(19) United States
(12) Patent Application Publication
(10) Pub. No.: US 2015/0213521 A1
(43) Pub. Date: Jul. 30, 2015

(54) ADAPTIVE SOCIAL MEDIA SCORING MODEL WITH REVIEWER INFLUENCE ALIGNMENT

(71) Applicant: The Toronto-Dominion Bank, Toronto (CA)

(72) Inventors: Prabaharan Sivashanmugam, Farmington Hills, MI (US); Michael D. Cummins, Pickering (CA); Lauren Van Heerden, Bedford, NH (US); Gunalan Nadarajah, Richmond Hill (CA); Orin Del Vecchio, Richmond Hill (CA); Talvis Pierre Love, Novi, MI (US)

(21) Appl. No.: 14/610,018

(22) Filed: Jan. 30, 2015

Related U.S. Application Data
(60) Provisional application No. 61/933,465, filed on Jan. 30, 2014.

(51) Int. Cl. G06Q 30/02

(52) U.S. Cl. CPC G06Q 30/0282

(57) ABSTRACT

Online reviews present a wealth of information for consumers to consider when making purchase decisions. Consumers however, can be disadvantaged by an inability to determine the usefulness of reviews, the wealth of information thus providing marginal utility. Where consumers can establish an affinity or trust with a reviewer, the usefulness of a review can be vetted against the perspective of the consumer, assisting consumers in making purchase decisions with greater confidence and reliability. Social media further supports consumers by providing a convenient pool of reviewers with whom a consumer may already have pre-existing relationships or familiarity with, bolstering the ability of the consumer to establish an affinity or trust with the reviewer. An adaptive influence process provides a method for consumers to adapt such a collection of reviews, and tailor them to the consumer's own perspective to assist in making purchase decisions with greater confidence.

### CROSS-REFERENCE

This application claims the benefit of U.S. Provisional Application No. 61/933,465 filed Jan. 30, 2014, the contents of which are incorporated herein by reference.

### FIELD

This disclosure relates to computer methods and systems for online reviews and more particularly to computer methods and systems for an adaptive social media scoring model where social media reviews are adapted to align with the readers of the reviews.

### BACKGROUND

The usefulness of online reviews for products and services continues to be a problem for individual readers of reviews. Individual consumers have access to a surplus of online product information, often without a reliable way to authenticate and otherwise judge the information's usefulness. In particular, the availability of online reviews for products and services presents consumers with a substantial amount of information that at times provides minimal assistance to consumers despite its significant potential to benefit purchase decisions.

### SUMMARY

Disclosed is an adaptive influence process where a product review score is generated from a collection of modified review scores reflecting the consumer's confidence, trust, alignment and/or other affinity with the authors of the reviews. In other words, the consumer's alignment to the reviewer can be leveraged to assist in determining the review's usefulness to the consumer. For example, reviews retrieved from social media network members linked to the consumer can be modified to reflect the consumer's alignment with the reviewer. Modified review scores can combine to produce a product review score to assist the consumer in making purchase decisions. This process is further responsive to consumer feedback for determining a measure of alignment between consumer and reviewer for adapting the influence of reviewers.

This summary is provided to introduce a simplified description of an adaptive influence process and is not to be understood as limiting the scope of the claimed subject matter. Other aspects, advantages, and novel features of the disclosure will become apparent from the detailed description and figures contained hereafter.

In one aspect there is provided a computer-implemented method of scoring reviews obtained from at least one reviewer in relation to a product and/or service of interest to a user. The method comprises; for each particular reviewer, retrieving using a computer at least one influence score for modifying the review of the particular reviewer, the at least one influence score responsive to a measure of alignment between the user and of the particular reviewer, the at least one influence score maintained in a database communicatively coupled to the computer; modifying individual reviews using the respective influence scores of the reviewers from the database for presentation to the user; and receiving, at the computer, feedback from the user regarding the individual reviews and adjusting the measure of alignment in response to the feedback to adaptively adjust the at least one influence score for a particular reviewer, storing to the database the at least one influence score as adapted.

Each influence score may be responsive to one or more measures received at the computer, the one or more measures including respective measures of reviewer credibility determined by the user; reviewer credibility determined by a social network associated with the user: reviewer formal education with respect to the product and/or service; and reviewer practical experience with respect to the product and/or service.

At least one influence score may comprise a global influence score for each reviewer and a specific influence score for each reviewer where the specific influence score is responsive to the product and/or service. If the specific influence score is available, the specific influence score may be used when modifying individual reviews.

The method may comprise receiving the reviews at the computer in response to a user request for reviews of the product and/or service from the reviewers. Reviewers and user may be members of a same one or more social networks and the request and reviews may be communicated via the same one or more social networks to the computer.

The feedback may comprise a user review from the user of the product and/or service and the step of adjusting comprises determining an alignment between the user review and the respective review of each particular reviewer. The feedback may comprise measures of user agreement with each of the individual reviews.

The method may comprise generating a final score to be presented to the user based on an aggregation and averaging of the individual reviews as modified.

In another aspect there is provided a computer-implemented method of searching a social media network for reviews from reviewers concerning a topic of interest to a user. The method may comprise determining using a computer the reviewers for the user from the social media network; communicating requests for respective reviews from the reviewers concerning the topic of interest; receiving respective reviews from the reviewers; for each particular reviewer, retrieving using the computer at least one influence score for modifying the review of the particular reviewer, the at least one influence score responsive to a measure of alignment between the user and the particular reviewer, the at least one influence score maintained in a database communicatively coupled to the computer; modifying individual respective review's using the respective influence scores of the reviewers from the database for presentation to the user; receiving, at the computer, feedback from the user regarding the respective individual reviews; and adjusting the measure of alignment for the particular reviewer in response to the feedback to adaptively adjust the at least one influence score for the particular reviewer, storing to the database the at least one influence score as adapted.

Computer system, computer program (e.g. a non-transitory computer medium storing instructions for configuring a computer system) as well as other aspects will also be apparent.

### BRIEF DESCRIPTION OF THE DRAWINGS

FIG. 1 is an illustration of social media computer architecture and a product review request originating from a computer and filtering through a social network to a computer server according to one example.

FIG. 2 illustrates the computer server of FIG. 1 in greater detail including an example process of receiving a collection of reviews for computing a review score from a product review request.

FIG. 3 is an illustration of an example process of adapting influence scores based on aligning the consumer's review with the reviewers in accordance with the computer server of FIG. 2.

### DETAILED DESCRIPTION

Reviewers known to the consumer can assist purchase decisions as the consumer may be better positioned to determine the usefulness of reviews where a relationship with the reviewer has been previously established. Social media networks represent one source of contacts, potentially providing a large pool of reviewers with whom the consumer may have pre-existing familiarity. Social media also supports creating and collecting reviews in real time, reflecting current opinions of products or services or other topics of interest. Some online providers of products and services provide repositories of online reviews that are stale and may not reflect up to date opinions.

A consumer's alignment to a reviewer may represent several factors including but not limited to, the consumer's trust in the reviewer, the reviewer's overall credibility and the reviewer's education and expertise in relation to the product or service under review. From another perspective. consumer alignment can be taken to reflect the reviewer's influence over the consumer. For example, when a reviewer has an education or job relating to computers and a consumer wishes to purchase a computer product, this particular reviewer may exercise greater influence over the purchase decision—consumers will tend to have greater confidence in reviewers with backgrounds in computers when making computer purchases.

Education and expertise represent some factors that may influence a consumer's purchase decision. Other factors to consider may include for example, the degree of trust or other affinity the consumer places in the reviewer. While education and expertise may present a reviewer in a positive light, other issues such as, biased opinions that question the reviewer's credibility may alert the consumer to proceed cautiously.

A review may be adapted to reflect a particular reviewer's influence over the consumer. Reviewer influence as previously discussed may represent several factors allowing consumers to adjust those factors per their affinities to the reviewer. Accordingly, a consumer may submit their own review or other form of feedback for comparison against other reviews, establishing an alignment with reviewers. Comparing reviews can this provide a baseline for determining how closely reviewer and consumer align. Where for example the consumer and reviewer provide very similar or identical reviews, the consumer's confidence and/or alignment with the reviewer may increase, reflecting their similar perspectives. As such, the reviewer's influence may adapt to reflect the consumer's increased confidence for subsequent reviews. It should be understood however, that this is one example of many possible methods for adjusting the reviewer's influence over the consumer.

As one may expect, a consumer's affinity towards a particular reviewer is not static and may change over time. Accordingly, alignment between consumer and reviewer may adapt and change over time. Any number of factors contributing to a consumer's affinity with a reviewer can change and effect their alignment. For example, a vegetarian consumer may be more aligned with reviewers with similar dietary habits and less aligned with reviewers with non-vegetarian habits. However, if the vegetarian consumer changes their dietary habits such that their diet now includes meat, their alignment with non-vegetarian reviewers may increase while their alignment with vegetarians may decrease.

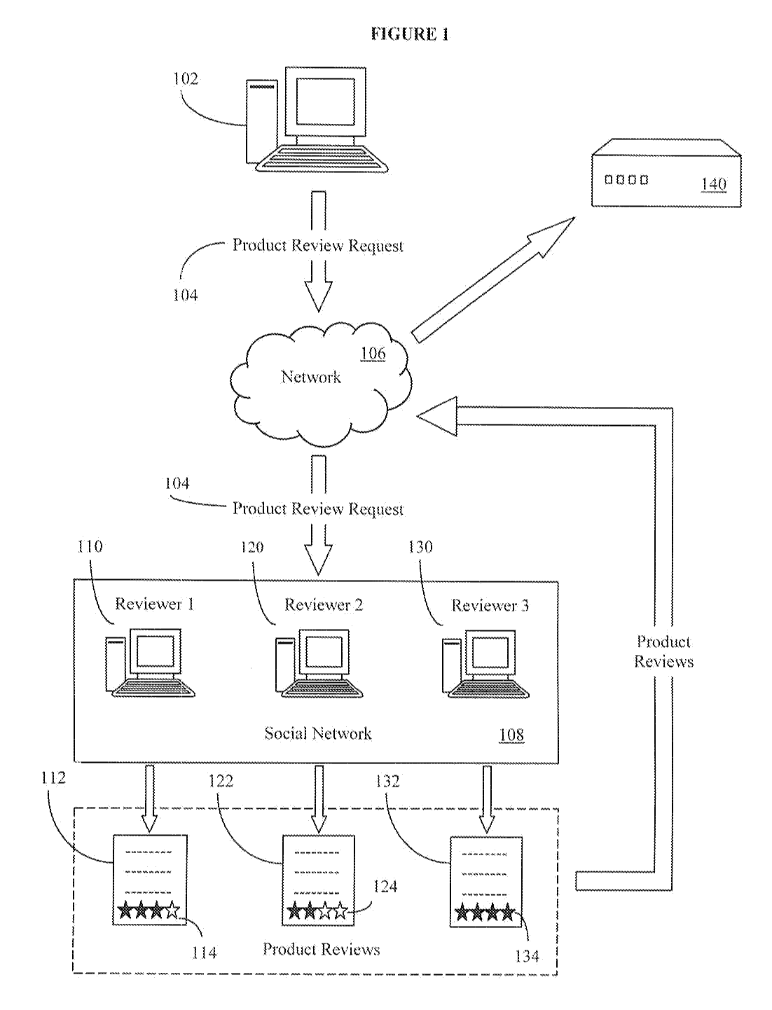

FIG. 1 depicts computer server 140 receiving a collection of information from network 106 including product review request 104. This example further illustrates product review request 104 originating from computer 102 and filtering through social network 108 to computer server 140 where product review request 104 relates to a product or service of interest to a consumer. A plurality of members connected to social network 108 are solicited to provide reviews with respect to product review request 104. The example in FIG. 1 depicts three respective computer devices 110, 120 and 130 of three respective members of social network 108. These members may operate the computing devices to provide, review one 112, review two 122 and review three 132; and, respective review scores 114, 124 and 134.

The computers (e.g. 102, 110, 120 and 130) depicted in FIG. 1 are illustrative of desktop computers but other devices are operationally interchangeable including smartphones, tablets, laptops, eBooks or thin clients. and other computing/communicating devices. Such devices typically comprise processors, memory and/or other storage devices, input/output devices, software (e.g. instructions and data to configure the processors) and communication systems for enabling participants to communicate, such as via one or more social networks.

Computer server 140 as depicted in FIGS. 1, 2 and 3 is illustrative of a system, such as a computer, capable of responding to requests across a network. Such devices typically comprise processors, memory and/or other storage devices including databases (e.g. relational databases or other data stores), input/output devices, software (e.g. instructions and data to configure the processors) and communication systems for enabling participants to communicate across a network.

Referring still to FIG. 1, review one 112 is prepared in relation to product review request 104. Review one 112 contains review score 114 reflecting the opinion of reviewer one in relation to product review request 104. A review score may represent numerical values or other mechanisms (e.g. Facebook ‘likes’), reflecting quality or other product attributes relating to product review request 104. Reviewer two and reviewer three respectively provide reviews 122 and 132 to product review request 104 in the same manner.

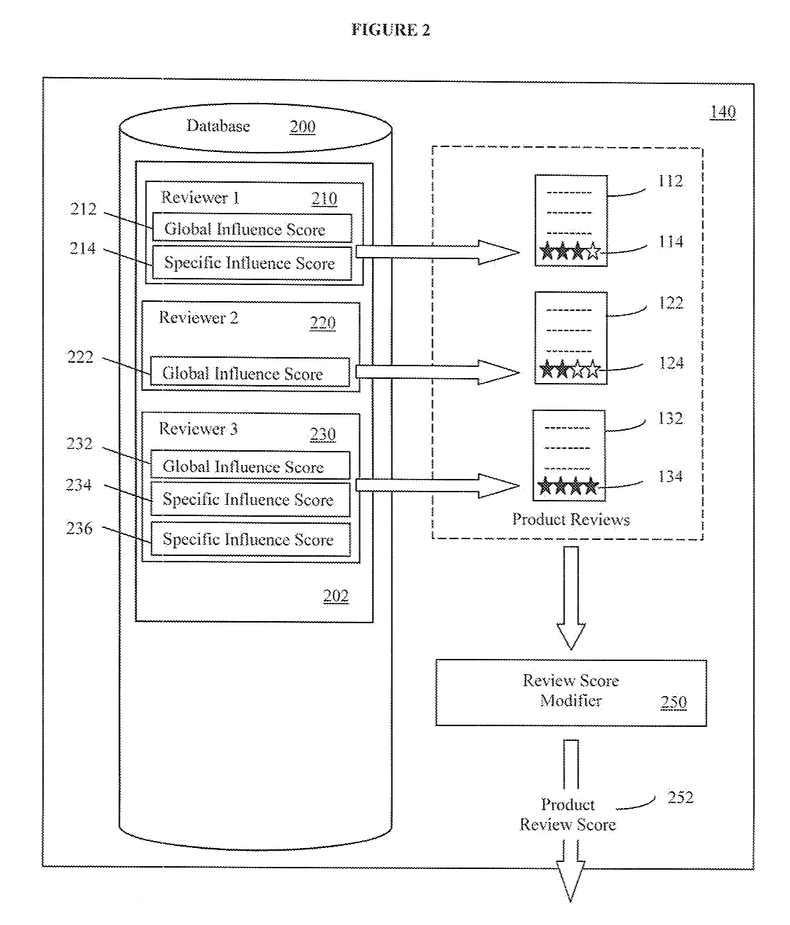

Computer server 140 receives each of review one 112, review two 122, review three 132 and product review request 104 over network 106. As explained in further detail below and depicted in FIG. 2, computer server 140 computes information submitted over network 106 to produce product review score 252, further transmitted over network 106 to computer 102 for consumer review.

FIG. 2 illustrates computer server 140 in great detail including an example for receiving a collection of reviews for computing product review score 252. Computer server 140 comprises database 200 and review score modifier 250. Database 200 may be a relational database or other data store operating as a repository of information related to consumers and reviewers. As depicted in FIG. 2, database 200 stores consumer memory unit 202 which further stores three reviewer memory units 210, 220 and 230 relating respectively to a first, second and third reviewer in association with the consumer. Reviewer memory unit 210 stores global influence score 212 and specific influence score 214 in association with a first reviewer and the consumer. Reviewer memory unit 220 stores global influence score 222 in association with a second reviewer and the consumer. Reviewer memory unit 230 stores global influence score 232, and specific influence scores 234 and 236 in association with a third reviewer and the consumer. It should be appreciated that database 200 is not limited to memory storage for one consumer and/or three reviewers as depicted in FIG. 2.

Influence scores can reflect any number of traits representative of a reviewer's influence with a consumer. Influence scores can be interchangeably viewed from the perspective of the consumer to represent trust, confidence or other affinities placed in the reviewer by the consumer. Global influence scores represent the overall influence established between reviewer and consumer; in other words, how much influence generally the reviewer has over the consumer. Specific influence scores however only represent influence established between consumer and reviewer within the context of a specific product and/or service. That is specific influence scores may be responsive to the product and/or service of product review request 104, where general influence scores may be less responsive. If for example product review request 104 relates to the purchase of to new computer and the individual reviewer has certification as a IT specialist, the specific influence score for this individual reviewer may be, at least initially, responsive to or weighted more heavily than other scores taking into account this qualification. Using the adaptive process, over time, the alignment of consumer and reviewer as determined from consumer feedback to the individual reviewer's reviews for this context or topic (e.g. IT) may modify the specific influence score, which may result in it increasing or decreasing the influence score.

Computer server 140 computes product review score 252 by inputting influence and review scores in to review score modifier 250. As depicted in FIG. 2, database 200 stores reviewer memory units 210, 220 and 230 in association with a first, second and third reviewer. Computer server 140 computes product review score 252 by retrieving an influence score from each of reviewer memory units 210, 220 and 230 for modifying, respectively, each of review score 114, 124 and 134 through review score modifier 250.

Computer server 140 may prefer one influence score over another when computing product review score 252. Referring to FIG. 2, if specific influence scores are preferred, specific influence score 214 may be used instead of global influence score 212 when modifying review score 114 in association with a first reviewer. Global influence score 222 is used by default when modifying review score 124 in association with a second reviewer since no specific influence score is available for that pairing of consumer and reviewer. Specific influence score 234 or specific influence score 236 may be used instead of global influence score 232 to modify review score 134 in association with a third reviewer. Selecting a specific influence score from a plurality of influence scores is contingent on product review request 104. When a specific influence score is related in context or topic to product review request 104 it can be used accordingly for modifying review scores. As such. product review score 252 as depicted in FIG. 2 reflects review scores 114, 124 and 134 modified respectively by one corresponding influence score stored in reviewer memory units 210, 220 and 230 by review score modifier 250. Once computed, computer server 140 may send product review score 252 over network 106 for the consumer to review.

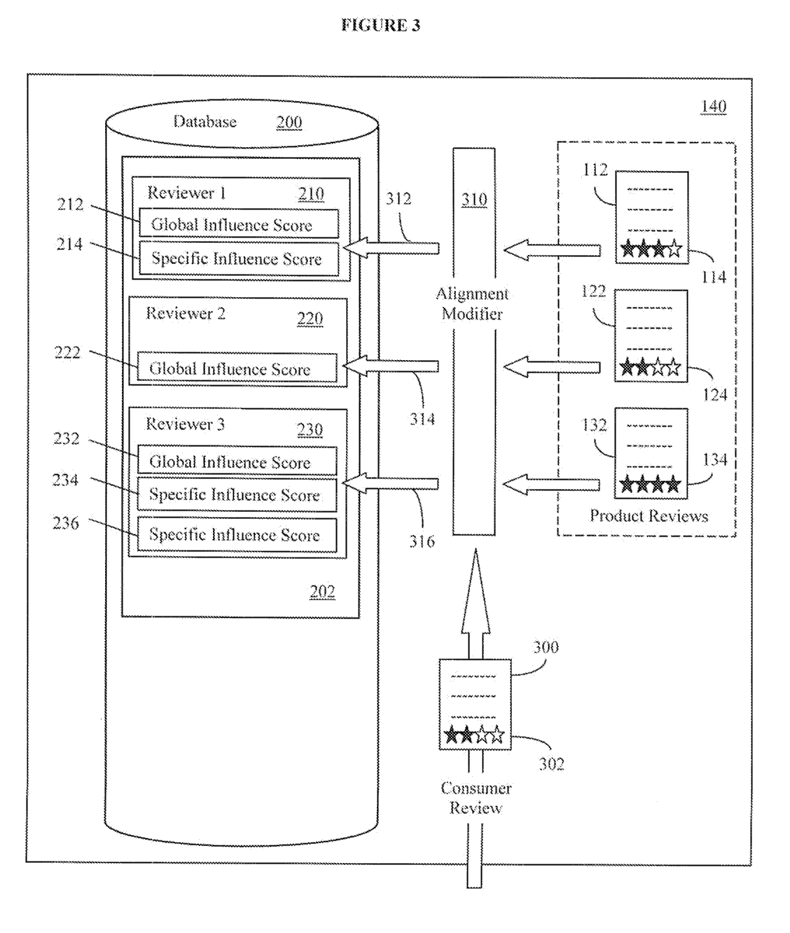

FIG. 3 illustrates an example process where computer server 140 adapts influence scores based on aligning consumer and reviewer in accordance with consumer review 300. Computer server 140 inputs consumer review score 302 and review scores 114, 124 and 134 in to alignment modification 310 which outputs alignment scores 312, 314 and 316 respectively associated with as first, second and third reviewer. Consumer review 300 and its associated consumer review score 302 may constitute an original review provided for by the consumer however, other mechanisms may also be used interchangeably in providing consumer review 300. For example, the consumer may select a review made available through its social network and adopt it as its own consumer review 300 for the purpose of alignment modification. Using Facebook as a further example, the consumer may ‘like’ a review made available through its Facebook network and submit it as consumer product review 300. Computer server 140 may then receive and input consumer product review 300 and its associated consumer review score 302 to alignment modification 310 for adapting influence scores.

Alignment modification 310 receives review scores as inputs in computing alignment scores for further use in adapting influence scores. As depicted in FIG. 3, alignment modification 310 receives review scores 114, 124 and 134 respectively associated with a first, second and third reviewer, for use in computing alignment scores 312, 314 and 316. correspondingly associated with a first, second and third reviewer. Alignment modification 310 also receives consumer review score 302 as an input. Alignment score 312 reflects the alignment between a first reviewer and the consumer as computed by comparing review score 114 with consumer review score 302. Similarly, alignment scores 314 and 316 respectively reflect the alignment between a second and third reviewer and the consumer by comparing review scores 124 and 134 with consumer review score 302. For example, alignment score 312 reflects alignment modification 310 by comparing the three star rating of review score 114 with the two star rating of consumer review score 302. Similarly, alignment scores 314 and 316 respectively reflect alignment modification 310 by comparing the two and four star ratings of review scores 124 and 134 with the two star rating of consumer review score 302.

Alignment scores 312, 314 and 316 operate to adapt—or possibly establish—influence scores. As depicted in FIG. 3, alignment scores 312, 314 and 316 operate to adapt influence scores stored in reviewer memory units 210, 220 and 230, respectively associated with a first, second and third reviewer. Whether or not an influence score is adapted depends on certain criteria. For example, specific influence scores may reflect a specific product or product type reviewed between a consumer/reviewer pair as opposed to a global influence score which may represent the entire set of products reviewed between a consumer/reviewer pair. Using such criteria, global influence scores corresponding to a particular reviewer consumer relationship may adapt when a new corresponding alignment score between the consumer/reviewer pair is computed. Conversely, specific influence scores may adapt to alignment scores when related in context or topic to a product review.

Considering the example depicted in FIG. 3, when alignment modification 310 outputs new alignment scores 312, 314 and 316 in association with a first, second and third reviewer, corresponding global influence scores 212, 222 and 232 may adapt to each of their respective alignment scores. Conversely, specific influence scores may adapt depending on product review request 104 which relates to a specific product or service. Where a specific influence score is associated with product review request 104, it may be responsive to alignment modification. For example, where specific influence score 214 is related in context or topic to product review request 104, alignment score 312 may adapt specific influence score 214. Similarly, where specific influence score 234 and/or specific influence score 236 relate in context or topic to product review request 104, alignment score 316 may adapt either or both of specific influence scores 234 and 236. Where alignment modification 310 for product review request 104 relates to a category of products or services not yet reviewed, a new specific influence score may be created.

Although this description presents a more detailed review of an adaptive influence process with reference to specific features and process steps, it should not be understood as limiting the scope of the claimed subject matter. In other words, the subject matter defined in the claims is not necessarily limited to the features described in the specification, rather the specification discloses examples for implementing the claims.

What is claimed is:

1. A computer-implemented method of scoring reviews obtained from at least one reviewer in relation to a product and/or service of interest to a user, the method comprising:
for each particular reviewer, retrieving using a computer at least one influence score for modifying the review of the particular reviewer, the at least one influence score responsive to a measure of alignment between the user and the particular reviewer, the at least one influence score maintained in a database communicatively coupled to the computer;
modifying individual reviews using the respective influence scores of the reviewers from the database for presentation to the user; and
receiving, at the computer, feedback from the user regarding the individual reviews and adjusting the measure of alignment for the particular reviewer in response to the feedback to adaptively adjust the at least one influence score for the particular reviewer, storing to the database the at least one influence score as adapted.

2. The method of claim 1 wherein each influence score is responsive to one or more measures received at the computer, the one or more measures including respective measures of:
reviewer credibility determined by the user;
reviewer credibility determined by a social network associated with the user;
reviewer formal education with respect to the product and/or service; and
reviewer practical experience with respect to the product and/or service,

3. The method of claim 2 wherein the at least one influence score comprises a global influence score for each reviewer and a specific influence score for each reviewer where the specific influence score is responsive to the product and/or service.

4. The method of claim 3 wherein it the specific influence score is available the specific influence score is used when modifying individual reviews.

5. The method of claim 1 comprising receiving the reviews at the computer in response to a user request for reviews of the product and/or service from the reviewers.

6. The method of claim 5 wherein the reviewers and user are members of a same one or more social networks, the request and reviews communicated via the same one or more social networks to the computer.

7. The method of claim 1 wherein the feedback comprises a user review from the user of the product and/or service and the step of adjusting comprises determining an alignment between the user review and the respective review of each particular reviewer.

8. The method of claim 1 wherein the feedback comprises a measure of user agreement with a particular individual review.

9. The method of claim 1 comprising generating a final score to be presented to the user based on an aggregation and averaging of the individual reviews as modified.

10. A computer system adapted for scoring reviews obtained from at least one reviewer in relation to a product and/or service of interest to a user, the computer system comprising:
a processor; and,
a memory unit including instructions and data that cause the computer system to perform the method of claim 1.

11. A computer program product for enabling a computer for scoring reviews obtained from at least one reviewer in relation to a product and/or service of interest to a user, the computer program product comprising a non-transitory computer readable medium storing instructions and data to enable a computer to perform a method of claim 1.

12. A computer implemented method of searching a social media network for reviews from reviewers concerning a topic of interest to a user comprising:
determining using a computer the reviewers for the user from the social media network;
communicating requests for respective reviews from the reviewers concerning the topic of interest;
receiving respective reviews from the reviewers;
for each particular reviewer, retrieving using the computer at least one influence score for modifying the review of the particular reviewer, the at least one influence score responsive to a measure of alignment between the user and the particular reviewer, the at least one influence score maintained in a database communicatively coupled to the computer;
modifying individual respective reviews using the respective influence scores of the reviewers from the database for presentation to the user;
receiving, at the computer, feedback from the user regarding the respective individual reviews; and
adjusting the measure of alignment for the particular reviewer in response to the feedback to adaptively adjust the at least one influence score for the particular reviewer, storing to the database the at least one influence score as adapted.

13. The method of claim 1 wherein each influence score is responsive to one or more measures received at the computer, the one or more measures including respective measures of:
reviewer credibility determined by the user;
reviewer credibility determined by a social network associated with the user;
reviewer formal education with respect to the topic of interest; and
reviewer practical experience with respect to the topic of interest.

14. The method of claim 13 wherein the topic of interest is a product or service.

15. The method of claim 13 wherein the at least one influence score comprises a global influence score for each reviewer and a specific influence score for each reviewer where the specific influence score is responsive to the product and/or service.

16. The method of claim 15 wherein if the specific influence score is available the specific influence score is used when modifying individual reviews.

17. The method of claim 12 comprising receiving the reviews at the computer in response to a user request for reviews of the product and/or service from the reviewers.

18. The method of claim 17 wherein the reviewers and user are members of a same one or more social networks, the request and reviews communicated via the same one or more social networks to the computer.

19. The method of claim 12 wherein the feedback comprises a user review from the user of the product and/or service and the step of adjusting comprises determining an alignment between the user review and the respective review of each particular reviewer.

20. The method of claim 12 wherein the feedback comprises a measure of user agreement with a particular individual review,

21. The method of claim 12 comprising generating a final score to be presented to the user based on an aggregation and averaging of the individual reviews as modified.
